(19) United States
(12) Patent Application Publication
(10) Pub. No.: US 2025/0132650 A1
(43) Pub. Date: Apr. 24, 2025

(54) ELECTRIC CURRENT GENERATION APPARATUS WITH IMPROVED EFFICIENCY

(71) Applicant: Alberto RONCAN, La Spezia (SP) (IT)

(72) Inventor: Alberto RONCAN, La Spezia (SP) (IT)

(21) Appl. No.: 18/572,391

(22) PCT Filed: Jun. 21, 2022
(86) PCT No.: PCT/EP2022/066864

§ 371 Date: Dec. 20, 2023

(30) Foreign Application Priority Data
Jun. 22, 2021 (IT) 102021000016361

(51) Int. Cl. H02K 16/00; H02K 11/01

(52) U.S. Cl. CPC H02K 16/00; H02K 11/014

(57) ABSTRACT

A description is given of an apparatus for the generation of electric current (1; 101; 201; 301; 351; 401; 501), comprising an armature element (10; 110; 210; 310; 360; 410; 510) supporting one or more electrical windings or conductors (12; 112; 212; 312; 362; 412; 512), appropriately arranged in a magnetic field generated by an inductor (20; 120; 320; 370; 420; 520), and optionally comprising a box structure (260) having an opening, whose surfaces have a magnetic shielding function and are intended to surround at least said armature element (10; 110; 210; 310; 360) on all sides except on the one corresponding to said opening, wherein, in operation, said armature element (10; 110; 210; 310; 360; 410; 510) is fixed and is maintained static with respect to the inductor (20; 120; 320; 370; 420; 520) and in that it comprises a shielding structure (30; 130; 230; 330; 380; 430; 530) supporting a plurality of sectors (32; 132; 232; 332; 382; 432; 532) with the function of a magnetic shield, and wherein said sectors with the function of a magnetic shield (32; 132; 232; 332; 382; 432; 532) are made up of a metal alloy comprising nickel and iron and have a thickness that varies between 0.003 mm and 3 mm, and in that said shielding structure (30; 130; 230; 330; 380; 430; 530) is set in rotation or in oscillation to cause a variation of the magnetic field and thus of the flux concatenated to said one or more windings or conductors (12; 112; 212; 312; 362; 412; 512) of the armature element (10; 110; 210; 310; 360; 410; 510).

The present invention relates to an apparatus for generating electric current. More particularly, the invention relates to an induction electric current generator, wherein relative movement between armature and inductor is eliminated, obtaining an improved overall efficiency.

### BACKGROUND OF THE INVENTION

As is known, current generators are systems capable of transforming mechanical energy into electrical energy through the phenomenon of electromagnetic induction. Electromagnetic induction is the phenomenon whereby if a conductor moves in a magnetic field, or more precisely, if the flux chained with the conductor varies, an electric current is induced in the latter.

Some principles of electrical energy production and of electromagnetism are therefore given here below:
a coil of a conductor immersed in a variable magnetic field (which can be obtained, for example, by setting coil and magnet in relative rotation or by moving the coil forwards and backwards) is passed through by an electric current;
a conductor wound spirally around a ferromagnetic body is momentarily traversed by an electric current when the latter becomes magnetised;
magnetic induction is the phenomenon whereby some substances defined as ferromagnetic (including iron, cobalt, nickel, numerous transition metals, and their alloys) become magnetised if placed in a magnetic field.

The magnetic field generated by a permanent magnet can be used to actuate generators or electric motors of small dimensions, while larger machines require the use of electromagnets. Standard generators are thus made up of two basic units: the inductor, i.e. the magnet (or electromagnet) with its windings, and the armature, i.e. the structure that carries the conductors immersed in the magnetic field and which are traversed by the induced current (in generators) or by the supply current (in motors) as the magnetic field flux changes. The armature generally consists of a laminated soft iron core around which conductors (or windings) are coiled.

Generally, the variation in magnetic field flux occurs as a result of the rotation of the armature. In modern-day current generators, the relative rotation between armature and inductor creates an alternation of magnetisation/demagnetisation of the armature by the inductor, which results in current flowing through the coils of the armature for the entire duration of the rotation.

One of the characteristics of currently widespread current generators is represented by the relatively low value of the overall efficiency, i.e. of the ratio between the useful power produced and the (mechanical) power used to produce it, in particular to set one component in motion with respect to the other. Here below a list is given of the most common systems currently in use for transforming mechanical energy into electric current (dynamos or alternators), and the relative average efficiencies:
diesel engines: theoretical 44%, real 25%;
petrol engines: theoretical 37%, real 15%;
thermoelectric power plants: gas-fired up to 45%; up to 60% in combined cycle plants;
hydroelectric power plants: 80/85%;
nuclear fission power plants: 43%;
wind generator, both vertical and horizontal axis, produces 30/50% of the average capacity, due to the course of the wind, whose speed may not be less than 3-5 m/sec and not higher than 20-25 m/sec for safety reasons.

The purpose of all these systems is to set the relative armature and inductor in relative motion, which are components with not inconsiderable masses. In addition, eddy currents are generated during motion, resulting in forces of resistance to the movement itself. It can therefore be appreciated how a considerable amount of energy is required, if compared to the amount of electrical energy obtained.

From what has been disclosed, it is clearly advantageous to redesign electric current generation systems, limiting the energy required to set the components in motion, in particular by using the concept of magnetic shielding for energy generation, which will be discussed in greater detail here below.

EP2806546A1 discloses an electrical machine comprising a tubular rotor body which is rotatable around a rotary axis, wherein the rotor body is made of a ferromagnetic material, such as iron. A first tubular stator body comprises at least two first windings which are connectable to an electric circuitry, wherein the at least two first windings are arranged one after another along a circumferential direction with respect to the rotary axis. A second tubular stator body comprises at least two magnetic sections which are arranged one after another along the circumferential direction, wherein each magnetic section comprises a respective magnetic element. The rotor body is rotatably supported between the first stator body and the second stator body. In an embodiment, the rotor body has a plurality of “teeth” arranged one after another along the circumferential direction.

The permanent magnets of the second stator body, during rotation of the rotor, magnetise the teeth of the rotor itself, which are made of iron (or ferromagnetic material), which demagnetise when they move away from the magnet. Soft iron demagnetises after moving away from the magnetisation source, unlike hard iron which, once magnetised, no longer demagnetises except under special conditions. Iron, in itself, is not an element that shields the magnetic field and, by induction, goes to be magnetised in turn.

In this case too, the rotation of the mass of the rotor body, also when it has a structure with teeth of ferromagnetic material (which are metallic elements of a size commensurate with the characteristics of the electrical machine), constitutes most of the energy expenditure, together with the forces that oppose the advancement of the rotor in its rotary motion, which always results in a relatively low energy yield.

JP6789451B1 describes an electrical machine (in particular an electric motor) that consists of a stator comprising permanent magnets, a second stator comprising windings and a rotor formed by a plurality of iron sectors. The object of this patent is to modify, in an electric motor, the torque required at low speeds or high speeds. This modification is obtained by means of appropriate counter-electromotor forces, given by the varying of the currents supplied to the electromagnets, which go to weaken, on demand, the magnetic field of the permanent magnets. Also in this document, the iron sectors of the rotor are intended to magnetise themselves during their rotatory movement within a magnetic field and the rotation of the rotor always results in a relatively low energy yield.

DE8901215U1 describes a generator of current obtained by induction generated by the terrestrial or interstellar magnetic field but does not cover the concept of magnetic shielding in the current generation process.

### SUMMARY OF THE INVENTION

The object of the present invention is therefore to provide an apparatus for generating electric current in which the overall efficiency is improved.

In particular, the object of the present invention to provide a current generation apparatus in which the relative movement between armature and inductor is eliminated, making innovative use of the concept of magnetic shielding in the current generation process.

Another object of the present invention is to provide a current generation apparatus in which the inductor consists entirely of the terrestrial magnetic field. Yet another object is to provide a current generation apparatus with improved efficiency that can easily replace systems currently in use.

These and other objects are achieved by a current generation apparatus with improved efficiency according to the invention having the features listed in the appended independent claim 1.

Advantageous embodiments of the invention are disclosed by the dependent claims.

Substantially, the present invention relates to an apparatus for generating electric current comprising an armature element supporting one or more electrical windings or conductors, appropriately placed in a magnetic field generated by an inductor, and optionally comprising a box structure having an opening, whose surfaces have a magnetic shield function and are intended to surround at least said armature element on all sides except on the side corresponding to said opening, wherein, in operation, said armature element is fixed and is maintained static with respect to the inductor, and wherein there is a shielding structure supporting a plurality of sectors with magnetic shield function wherein the sectors with function of magnetic shield are made from a metal alloy comprising nickel and iron and have a thickness that varies between 0.003 mm and 3 mm and wherein said shielding structure is rotated or oscillated to cause a variation of the magnetic field and thus of the flux linked to said one or more windings or conductors of the armature element.

### BRIEF DESCRIPTION OF THE DRAWINGS

Further features of the invention will be made clearer by the following detailed description, referring to an embodiment thereof purely by way of a non-limiting example, illustrated in the accompanying drawings, in which:

FIG. 1 is an axonometric view, partially blown up, of an apparatus for generating electric current according to a first embodiment of the invention;

FIG. 2 is a cross section view of the components of the apparatus according to the first embodiment;

FIG. 3 is an axonometric view of an electric current generation apparatus according to a second embodiment of the invention;

FIG. 4 is a cross section view of the embodiment shown in FIG. 3;

FIG. 5 is a schematic axonometric view of an electric current generation apparatus according to a third embodiment of the invention;

FIG. 6a is a blown-up axonometric view showing the components of an electric current generation apparatus according to a fourth embodiment of the invention;

FIG. 6b is a blown-up axonometric view showing an alternative embodiment of the electric current generation apparatus shown in FIG. 6a;

FIG. 7 is an axonometric illustration showing a further embodiment of the invention made up of flat structures;

FIG. 8 is an axonometric illustration of a further embodiment of the invention made up of a series of coaxial cylinders, wherein the intermediate cylinder supports a plurality of shielding sectors;

FIG. 9 is a schematic illustration corresponding to a plane perpendicular to the axis of the coaxial cylinders of FIG. 8 showing a circumferential arrangement of shielding sectors and armature and inductor sectors; and

FIG. 10 is a schematic illustration showing the position of the shielding sectors of FIG. 8 after having applied an oscillatory motion to the shielding structure.

### DETAILED DESCRIPTION OF THE INVENTION

Before describing in detail the specific embodiments of the present invention, it is appropriate to introduce the concept of magnetic shielding, i.e. a system capable of attracting, focusing and deflecting the lines of the magnetic field (m.f.) generated by a source, preventing them from entering a given volume and likewise reducing the diffusion of the magnetic field itself. A magnetic shield can be represented, for example, by a sheet composed of an alloy of various elements, suitably shaped and of variable thickness, determined on the basis of the intensity of the magnetic field to be shielded and of the need to avoid saturation thereof. A magnetic shield typically consists of an alloy mainly of nickel and iron, and containing in a smaller quantity molybdenum, carbon, silicon, manganese, to a variable extent according to the manufacturer and the characteristics of the magnetic field. Preferably, it is characterised by the absence or minimal presence of openings, by having rounded corners and the smallest possible dimensions, compatible with the magnetic field to be shielded. The effectiveness of a magnetic shield depends on the permeability of the material which, in the case of ferromagnetic materials such as those used, varies as the magnetic field varies. The effectiveness of the shield in fact decreases both in the case of very low intensity of the magnetic field and in the case of high intensity, a situation in which the material becomes saturated.

In order to obtain low residual fields (high field attenuation), magnetic shields often consist of several ‘cages’ placed one inside the other, each of which causes in succession an attenuation of the field in its interior. This solution is advantageous above all when it is considered that a simple flat panel has less of a shielding effect than a panel having the edges bent into a box, which is a configuration apt to better direct the magnetic field lines.

Magnetic fields of the order of milligauss (mG) or equivalently of tenths of a microtesla (μT) require alloys with high magnetic permeability and low saturation in order to be shielded; fields of over 1 G, on the contrary, require alloys with low magnetic permeability and high saturation.

The thicknesses used for magnetic shields of the above type range from 0.03 to 3 mm and more. The sheets used must be protected from oxidation with paints, nickel-plating, tin-plating or other means. Handling them without the use of gloves can have oxidising effects, as can bending and welding which, by causing internal tensions, alter the microcrystalline structure that characterises high or low magnetic permeability.

For these reasons, after processing, the magnetic shields must again be subjected to high temperatures—so-called annealing—in order to reorganise the microcrystalline structure. The magnetic field that impinges on a shield will have the lines of the field physically within the thickness of the material. In the case wherein the shield undergoes mechanical stresses and/or plastic deformations, the shielding effect decreases or may even disappear. Conversely, in the absence of such stresses and of oxidation, the shielding effect is long-lasting. At present, there are also suitable resins and paints which, within certain limits, tend to shield the magnetic field.

The electrical energy production systems that are the subject of the present invention are based on the practical application of the shielding effects just described. Independently of the size of the inductor and armature, whether in the case of a dynamo or alternator, the operating principle is based on keeping the armature and inductor, or their equivalents, static and generating a variable magnetic field by means of a shielding structure.

Referring to known systems, and in particular to those described in the documents cited in the section relating to the background of the invention, no apparatus utilises the concept of magnetic shielding by providing a rotating structure that supports shielding sectors having the features described (i.e. formed by metal alloy sheets with thicknesses ranging from 0.03 to 3 mm) for the production of energy.

In the case of EP2806546A1, in fact, the magnetisation of the iron ‘teeth’ induces a current, during the flux variation due to the rotation of the rotor, in the windings. The teeth of the rotor do not act as a magnetic shield, but rather as an excitation element, once magnetised by induction, of the windings, and the fact of moving the hot windings away from the permanent magnets makes it possible to eliminate the thermal effects of the windings on the magnets themselves. Also in JP6789451B1, the rotor is formed by a series of iron elements, the purpose of which is to pass the magnetic flux generated by the permanent magnet by magnetisation and have no shielding effect on the magnetic field.

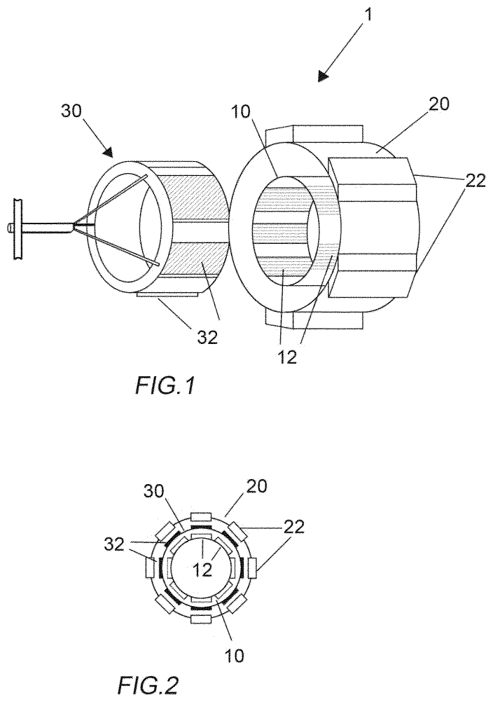

FIG. 1 (which is a partially blown-up axonometric view) and FIG. 2 (which is a section view) show a first embodiment of a current generation apparatus 1 according to the invention formed by an inner cylindrical surface 10 (or analogously a cylindrical crown or a hollow cylinder) supporting a plurality of windings or conductors 12 and an outer cylindrical surface 20 (or analogously a cylindrical crown or a hollow cylinder) supporting a plurality of induction elements (magnets or electromagnets) 22. By analogy with known generation systems, the inner cylinder 10 will also be referred to as ‘armature’, while the outer cylinder 20 will generally be referred to as the ‘inductor’. The windings 12 of the armature and the induction elements 22 will also generally be referred to as ‘sectors’. The armature can also be indifferently placed on the outer cylindrical surface, in which case the inductor will be placed on the inner cylindrical surface.

In operation, armature 10 and inductor 20 are maintained static, with sectors 12 of the armature and sectors 22 of the inductor positioned opposite each other. Between armature 10 and inductor 20 is placed a cylindrical crown 30 of diamagnetic material, fixed at its distal end to an axis capable of rotation. On the surface of the cylindrical crown 30 are placed, in a regular manner and in a number equal to the induction sectors 22 of the generator—or in an appropriate number as a function of the qualitative and quantitative characteristics of the current to be produced—a plurality of shielding sectors 32, having the features of the magnetic shields described above. The cylindrical crown 30 acts therefore as a shielding structure.

The shielding structure 30 is of adequate thickness as a function of the load to be supported and has dimensions such as to allow its insertion in the generator air gap, i.e. the space between armature 10 and inductor 20, seeking to maintain the size of this air gap as low as possible. The axis of the shielding structure or circular crown 30 is closely connected to a pulley (or directly to a mechanical energy producer, which can be a motor, turbine, wind turbine blade or other) on which a rotating force is applied to set the same in rotation.

In operation, i.e. with the shielding structure 30 in motion, the rotation of the shielding sectors 32 causes a continuous magnetisation and demagnetisation of the armature sectors 10, in the same way as in traditional current generators. The main difference with respect to these conventional systems is that the power used to obtain the same current is far less. In fact, components such as standard armatures and inductors have much greater masses than a shielding structure 30 can have, so that their rotation requires considerably higher power. Furthermore, in the embodiment illustrated above, the forces opposing the relative movement of inductor and armature are diminished, practically eliminated, given the low magnetisation intensity of the shielding materials when subjected to a magnetic field, which are therefore attracted by a magnet to a much lesser degree with respect to the magnetic attraction generated between armature and inductor.

Through the use of this apparatus, the overall efficiency can be greatly increased, reducing the use of carburants or of fuels and the size of the plants. The rotary motion can also be caused by an electric motor, and the inductors can be formed by permanent magnets, electromagnets, or a mixed system.

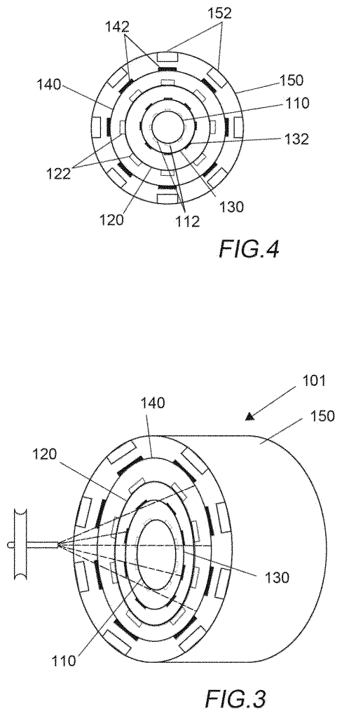

A second embodiment of the present invention extends the concept of functioning of the generation apparatus just described by applying an additional shielding structure. FIG. 3 shows an axonometric view of a current generation apparatus 101 that has alternating cylindrical surfaces (or cylindrical crowns) which assume the same function as the armatures, inductors and shielding structures described above.

Referring to the section view of FIG. 4, it can be appreciated that a first armature 110 having a plurality of windings 112, a first shielding structure 130 having a plurality of shielding sectors 132 and an inductor 120 having a plurality of induction sectors 122 are provided from the inside towards the outside. Externally to the latter, a second inductor 150 is provided (of naturally larger diameter) having a plurality of windings 152 and placed at a distance such as to allow the insertion between them of a second shielding structure 140 in the form of a cylindrical crown, fixed integrally to the axis of the first shielding structure 130 or to another axis that can rotate independently from the first one. The second shielding structure 140 also has a plurality of shielding sectors 142.

In this way, the magnetic excitation of two different armatures is obtained with a single inductor 120, with production of electric current from both armature elements 110, 150, thereby multiplying the amount of electrical energy obtained. In this embodiment, the magnets (or electromagnets) of the inductor must be fixed on the inductor element 120 in such a way as to produce induction towards both armatures 110, 150.

A further embodiment of the present invention consists in providing the terrestrial magnetic field as inductor, considering it in the same manner as a magnetic field produced by a magnet or by an electromagnet

The terrestrial magnetic field (tmf) is a quasi-dipolar magnetic moment, generated in the centre of the earth and with the axis almost parallel to the earth's axis of rotation. Leaving aside the complex mechanisms of magneto-fluid dynamics inherent to the earth's core, which are responsible for the magnetic field lines and their time and space variations, it can be said that the intensity of the terrestrial magnetic field varies from area to area of the earth's surface, increasing from approximately 24,000 nT near the equatorial zones to a maximum of 68,000 nT near the polar zones. Although the terrestrial magnetic field is relatively weak, it is still a magnetic field, and as such can be exploited.

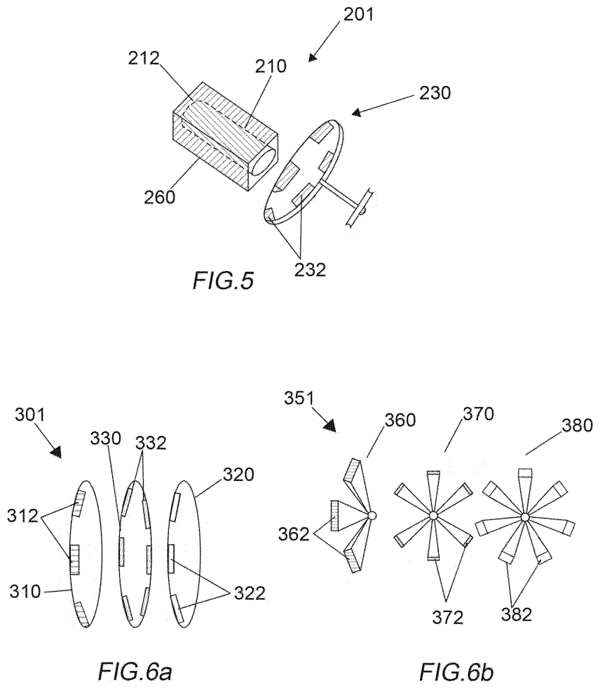

FIG. 5 shows a power generation apparatus 201 in which the earth's core is used as a magnetic field inductor. A ferrous core 210 is wound by a winding 212 in the same manner as an armature in a current generator. The ferrous core or armature element 210 is surrounded on all sides, except at one of its front parts corresponding to one of the bases, by a magnetic shield 260 substantially in the form of an open box. At the front opening, on the other hand, a shielding structure 230 is provided, like those already described, supporting a plurality of shielding sectors 232.

By positioning the armature 210 in the direction of the lines of the terrestrial magnetic field and rotating the shielding structure 230, a continuous magnetisation and demagnetisation of the ferrous core, caused by the terrestrial magnetic field lines, and consequent passage of current in the winding 212, will take place by induction. In this way, a current generation apparatus is obtained without the use of a specially designed inductor. The fact of surrounding the armature 210 on all sides, as just described, can also be applied to previous embodiments.

Naturally, considering the low intensity of the terrestrial magnetic field, it is necessary to consider an equivalent armature consisting of a high number of elements in order to obtain a current of a certain value.

As anticipated, DE8901215U1 describes a current generator obtained by induction generated by the terrestrial or interstellar magnetic field. In the document, the concept of magnetic shielding is considered, explaining that it serves, as a rule, in conventional generators, to prevent the magnetic field of the electromagnet or of the permanent magnet from being disturbed by the terrestrial magnetic field, which, as a disturbing agent, is not used in this context for the production of electric current.

According to the present invention, on the contrary, the flux of the terrestrial magnetic field goes to impinge along the axis of the armature 210, which is kept static. A plurality of magnetic shields, placed on a disc or radial structure made of diamagnetic material, are rotated in front of the opening of the box structure 260. This alternating covering/uncovering of the open part of the box structure allows the resulting variation of the terrestrial magnetic flux to generate an induction of the ferrous core in the armature, and the consequent passage of electric current in the winding of the armature itself. All this results in an innovative manner of generating electric current not covered in the description of DE8901215U1.

FIG. 5 shows shielding sectors 232 attached to a disc, rather than on the surface of a cylinder or cylindrical crown, but the shielding structure 230 can also be formed in a radial pattern. The substitution of cylindrical structures with discoidal or radial structures, or with structures of any type capable of being set in rotation, is actually possible for any of the embodiments already described.

It is therefore possible to replace the cylindrical surface structures of armatures and inductors with discoidal or radial structures, without departing from the scope of the present invention. FIG. 6a shows an embodiment 301 comprising a discoidal armature element 310 supporting the relative windings 312 and an inductor element 320 with respective induction elements 322. A disc-shaped shielding structure 330 supporting a plurality of shielding sectors 332 is interposed between the two discs. As in all previously disclosed embodiments, armature 310 and inductor 320 are maintained static with respective sectors 312 and 322 opposed, while shielding structure 330 is set in rotation.

In a manner entirely analogous to the embodiment just described, it is possible to provide a current generation apparatus 351 with radial, rather than discoidal, structures for armature 360, inductor 370 and shielding structure 380, such as those shown by way of example in FIG. 6b, supporting respective windings 362, induction elements 372 and shielding sectors 382. FIG. 6b shows an induction element 360 with three windings 362, but it is understood that in the preferred embodiment the number of windings 362 is equal to the number of induction elements 372, maintained static and in correspondence one with the other. In FIG. 6b, the structure 380 carrying the shielding sectors 382 is external to the armature system 360 and inductor 370, but normally has to be inserted between these two.

Furthermore, as in the second embodiment described herein, it is possible to provide for the use of a further shielding structure, disc or radial, placed between the inductor and a second armature element supporting relative windings, placed on the opposite side, so as to obtain the excitation of two different armatures by the same inductor.

The number of sectors of the armature 310, 360 and of the inductor 320, 370 may be one or more, as in the first and second embodiments, while the number of shielding sectors 332 of the shielding structure 330 and the speed of rotation of the disc or of the radial structure are suitably established according to the characteristics of the current to be produced.

The embodiments described hitherto all provide for a rotating magnetic shielding system inserted between armature and inductor, both maintained static one with respect to the other. The reciprocal position of armature and inductor can be variable, in the sense that the armature can be placed inside the shielding sector and the inductor, or vice versa. The deactivation and activation, respectively, of the electromagnetic induction responsible for the production of electric current in the armature are caused by the fact that the shielding sectors are located or not at the inductor (or armature) sectors during the rotation of the shielding cylinder (30; 130), or of the shielding disc (230; 330; 380) in the case of the disc or radial system.

Further embodiments of the invention provide for the relative receding and overlapping of the shielding sectors with respect to the inductor (or armature) sectors, in addition to by rotation, to also take place by means of a rotary oscillation of the shielding cylinder (30; 130) or the shielding disc (230; 330; 80) around its axis. The amplitude of the necessary oscillation is a function of the amplitude of the inductor (or armature) sectors, which also determines the size of the shielding sectors, in such a way that, during the oscillation, there is continuous covering/uncovering of the shielding sectors with respect to the inductor (or armature) sectors. The oscillatory solution applies as regards a rotatory, complete rotation or oscillating system. Oscillation can be achieved by any mechanical, electromechanical, electromagnetic or other method. Such an oscillatory rotation can therefore be easily implemented in any of the systems already described and shown in the various drawings.

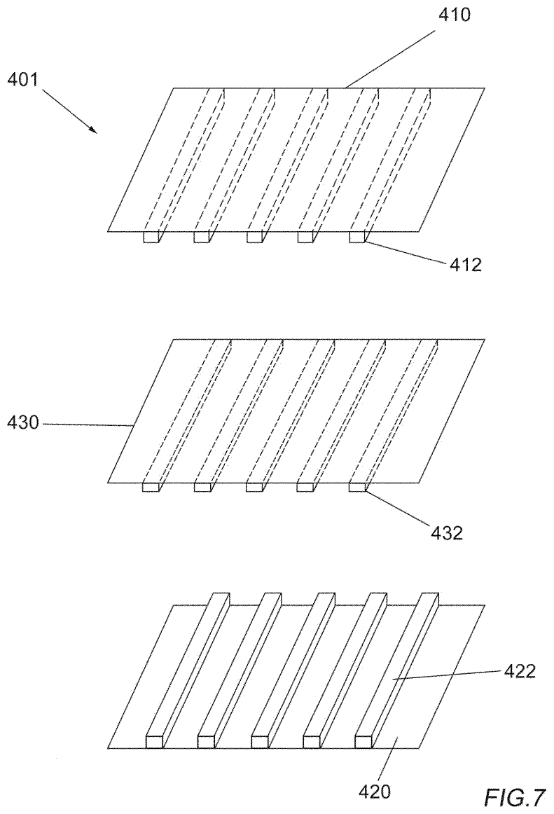

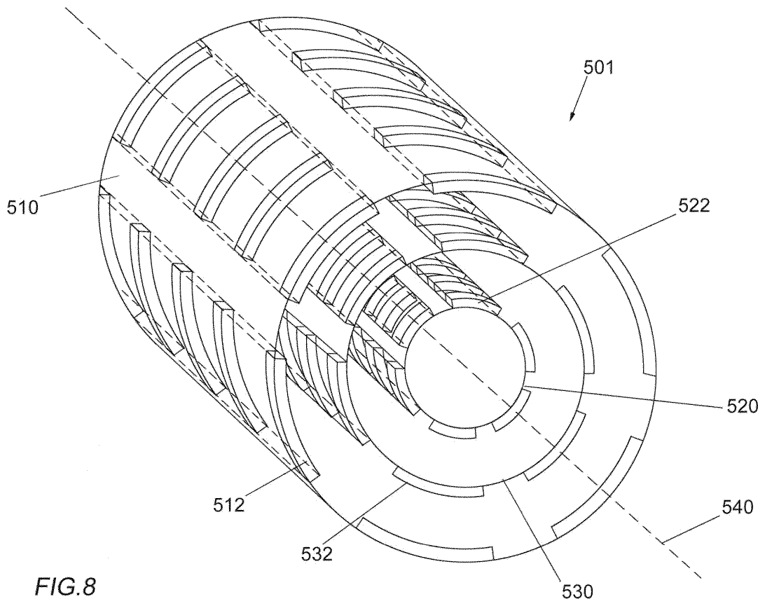

The same concept of covering/uncovering the magnetic shield can be considered in the case wherein the inductor, shielding structure and armature are formed by substantially planar structures with any geometrical shape (circle, square, rectangle, etc.) located on three parallel planes. FIG. 7 shows, by way of example, a structure 401 formed by three planar elements of rectangular shape, corresponding respectively to an armature element 410, a shielding structure or plane 430 and an inductor element 420. The armature element 410 has a series of electrical windings or conductor sectors 412, while the inductor element 420 has a plurality of induction elements (magnets or electromagnets) 422.

Inductor 420 and armature 410 are maintained fixed, with the sectors 412 of the armature corresponding in number to the sectors 422 of the inductor so as to be positioned opposite one to the other. The shielding plane 430 provides a plurality of sectors 432 with magnetic shielding function having the shielding characteristics described previously and is connected to an oscillating system which allows a translatory oscillating movement of the shielding plane, coplanar to the shielding plane and parallel to the inductor and armature planes, aimed at making shielding sectors 432 oscillate between the armature and inductor sectors.

Such a translation makes it possible to obtain a continuous alternation of the shielding of the inductor (or of the armature) sectors for each phase of the oscillation of the shielding plane, which will result in a variation of the magnetic field necessary for causing the electromagnetic induction in the armature.

Also in the oscillation cases just described (oscillation of the cylinder around its axis, of the disc or of the shielding plane), an additional shielding support and a second armature element can be provided, in such a way as to obtain the advantages previously set forth for structures with a same inductor and two armatures.

In all these variants with respect to rotation, in operation, each sector with function of magnetic shield moves, oscillating, between a position at a sector of the armature (or of the inductor), which is ‘covered’ and thus shielded, and a position where this sector is ‘uncovered’, stopping in the space between two sectors and then returning into the initial position to repeat the movement cyclically. Alternatively, the oscillatory movement may provide that the shielding sector, after its return phase towards the position at the armature sector (or inductor sector), may pass over this sector and come to cover a different armature sector, to then perform the movement cyclically. The choice will be made as a function of the amplitude of the oscillation that is convenient to adopt. Since the shielding structure is composed of one or more sectors of shielding material, it is evident that each covering/uncovering of the armature (or of the inductor) will be common to all the respective sectors.

A further embodiment of the invention based on the use of a magnetic shield for the production of electrical energy provides for the use of hollow cylinders, or equivalently any other ‘hollow’ or ‘open’ solid geometrical shape (parallelepiped, etc.). In the case of a cylinder structure, of which FIG. 8 shows an axonometric schematic view, a first hollow cylinder 510 is provided as the inductor element, with the inductor sectors 512 arranged circumferentially on one or more planes perpendicular to the axis 540 of the cylinder.

In the case of another solid figure, the sectors are arranged circumferentially on one or more planes perpendicular to this solid geometric figure. Inside the hollow cylinder (or other solid geometric figure), a second cylinder 520 (or other corresponding solid geometric figure) is coaxially arranged as armature element, with respective armature sectors 522 circumferentially (or perimetrically) arranged at those of the inductor.

Between the two armature and inductor elements is interposed a cylinder 530 (or other solid geometrical figure) carrying the shielding sectors 532 having the characteristics of magnetic shield of the other embodiments. Also in this case, the magnetic shielding sectors are circumferentially (or perimetrically) arranged on one or more planes, so as to correspond, in an unstressed state, to the corresponding armature and inductor sectors.

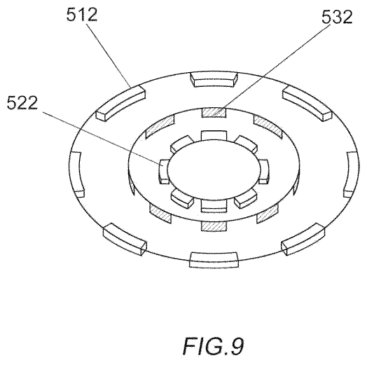

In the case of an embodiment formed by cylindrical structures and shown in FIG. 8, all shielding and armature/inductor sectors are curved, since they must be applied circumferentially to the curved surfaces of the cylinders. FIG. 9 is a schematic illustration, corresponding to one of the planes perpendicular to the axis 540 of the cylinders, of the circumferential arrangement of the inductor sectors 512, of the armature sectors 522 and of the magnetic shielding sectors 532, in a condition in which the shielding sectors 532 are on the same plane as the armature and inductor sectors.

In this coaxial structures embodiment, a movement of oscillation, similar in type to what happens in the cylinder of an internal combustion engine, produces the alternation of magnetisation/demagnetisation of the armature. The oscillation is therefore axial and can be obtained by any mechanical, electromechanical, electromagnetic or other method. The number of induction sectors, shielding sectors and armature sectors is a function of the type of current to be produced.

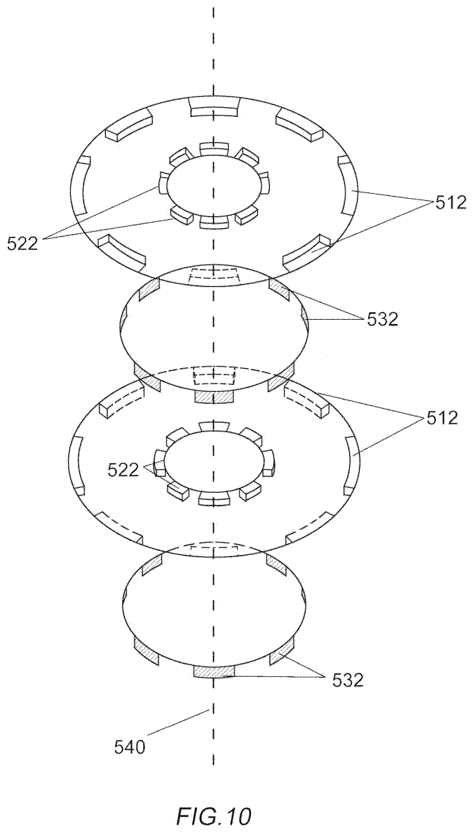

FIG. 10 is a schematic illustration showing the position of the shielding sectors 532 of a cylindrical support structure (not shown in the drawing) after it has undergone an oscillation along axis 540. The shielding sectors 532 are on different planes from those of the armature and inductor sectors (512, 522). The oscillatory movement causes the sectors 532 to move between a configuration in which they are coplanar and at the armature and inductor sectors (which are shielded) and a configuration in which the sectors 532 do not shield the armature and inductor sectors.

All the features and advantages of the invention already described also apply to these further embodiments that provide for the use of a structure with axially oscillating magnetic shielding. In all the cases described above, the armature and inductor sectors will be variable in number (from one onwards), according to the characteristic of the current production to be obtained. The shielding sectors may also be variable in number (from one onwards).

In all the cases set forth above, when speaking of “cylinders” or “parallelepipeds” or any other geometrical figure forming the armature or inductor elements or shielding structure, the structure of the same may be both with a solid lateral surface, a cage, a lattice or other. In the case of the use of “planes” the concept of “lateral surface” is to be understood with the word “flat”. In any case, any type of structure suitable for housing the induction, armature and shielding sectors is to be understood.

In all the embodiments, all the sectors of the shielding structure, in order to reduce the air gap as far as possible, can be placed either on the surfaces internal or external to the frame/support, whatever type it may be, or in the thickness of the frame/support itself, by means of suitable cavities. Furthermore, the concept that the inductor can be located irrespectively outside the armature, or vice versa, is always valid.

Thanks to the current generation apparatuses described above, it is therefore possible to significantly increase the overall efficiency, reducing the use of carburants or of fuels and the size of the plants. The rotatory or oscillatory motion of the shielding structures can also be produced by an electric motor.

Naturally the invention is not limited to the particular embodiments described above and illustrated in the accompanying drawings, but numerous detailed changes may be made thereto within the reach of the person skilled in the art, without thereby departing from the scope of the invention itself, as defined by the appended claims.

1-14. (canceled)

15. An electric current generation apparatus comprising an armature element supporting one or more electrical windings or conductors, suitably arranged in a magnetic field generated by an inductor, and optionally comprising a box structure having an opening, whose surfaces have a magnetic shield function and are intended to surround at least said armature element on all sides except the one corresponding to said opening,
wherein, in operation, said armature element is fixed and is maintained static with respect to the inductor and in that it comprises a shielding structure supporting a plurality of sectors with the function of a magnetic shield,
characterised in that said sectors with magnetic shield function are made up of an alloy of nickel and iron, said alloy containing also molybdenum, carbon, silicon, manganese, and have a thickness that varies between 0.03 mm and 3 mm and in that said shielding structure is set to rotate or oscillate to cause a change in the magnetic field and therefore in the flux concatenated to said one or more windings or conductors of the armature element.

16. The electric current generation apparatus according to claim 15, characterised in that:
the armature element is in the form of a cylindrical surface, a hollow cylinder or a cylindrical crown, said armature element having on its surface one or more windings and being coaxial to a cylindrical surface or to a hollow cylinder or to a cylindrical crown of greater diameter having the function of an inductor and having on its surface one or more induction elements arranged in such a way that each of them is located at a respective winding of the armature element; and
said shielding structure supporting a plurality of shielding sectors is represented by a cylindrical crown placed coaxially in the air gap between armature element and inductor and which in operation is set in rotation or in rotatory oscillation around its axis.

17. The electric current generation apparatus according to claim 16, further comprising:
a second static armature element in the form of a cylindrical surface or a hollow cylinder or a cylindrical crown placed externally and coaxially to the inductor and supporting one or more windings placed in such a way that each one of them is located at a respective induction element of the inductor; and
a second movable shielding structure supporting a plurality of shielding sectors with a magnetic shielding function in the form of a cylindrical crown placed in the air gap between the second armature element and the inductor coaxial to all the structures provided and capable of rotating or oscillating in a rotatory manner around its axis in a manner integral with the first shielding structure or independently thereof.

18. The electric current generation apparatus according to claim 15, characterised in that:
said armature element and said inductor are fixed discoidal structures peripherally supporting respective windings and induction elements, said discoidal structures being coaxially arranged and in such a way that each winding is located at a respective induction sector; and
said shielding structure is represented by a disc peripherally supporting a plurality of shielding sectors coaxially arranged between said armature element and said inductor, wherein said shielding structure in operation is set in rotation or in rotatory oscillation around its axis.

19. The electric current generation apparatus according to claim 18, further comprising a second shielding structure represented by a disc peripherally supporting a plurality of shielding sectors placed coaxially between said inductor and a second fixed armature element with discoidal structure peripherally supporting one or more windings arranged in such a way that each of them is located at a respective induction secto.

20. The electric power generation apparatus according to claim 15, characterised in that:
said armature element and said inductor are fixed radial structures peripherally supporting respective windings and induction elements, said radial structures being coaxially arranged and in such a way that each winding is located at a respective induction sector; and
said shielding structure is represented by a radial structure peripherally supporting a plurality of shielding sectors coaxially placed between said armature element and said inductor, wherein said shielding structure in operation is set in rotation or rotatory oscillation around its axis.

21. The electric current generation apparatus according to claim 20, further comprising a second shielding structure formed by a radial structure supporting a plurality of shielding sectors placed coaxially between said inductor and a second fixed armature element with radial structure supporting one or more windings placed in such a way that each of them is located at a respective induction sector.

22. The electric current generation apparatus according to claim 15, characterised in that:
said inductor is represented by the earth's core;
said armature element is represented by a ferrous core around which a winding is axially wound;
said ferrous core is placed in the direction of the earth's magnetic field lines and is surrounded by said closed box structure on all sides except for a part corresponding to a base of the ferrous core supporting the winding;
said shielding structure supporting a plurality of sectors with magnetic shielding function is placed at said opening of the box structure and is set in rotation or in rotatory oscillation.

23. The electric current generation apparatus according to claim 22, wherein said shielding structure is a cylinder, a hollow cylinder, a disc structure or a radial structure on the periphery of which are arranged said plurality of shielding sectors.

24. An electric current generation system, characterised in that it comprises a series of electric current generation apparatuses according to claim 8 connected one to the other.

25. The electric current generation apparatus according to claim 15, consisting of
a fixed armature element of flat shape, preferably rectangular, having one or more electrical windings or conductor sectors;
a fixed inductor element of flat, preferably rectangular, shape, having one or more induction elements arranged in such a way that each of them is located at a respective winding of the armature element;
a shielding structure of a flat, preferably rectangular, shape, supporting said sectors with function of magnetic shield;
wherein said shielding structure is in translatory oscillation coplanar to the plane of the same shielding structure and parallel to the planes of inductor and armature (420).

26. The electric current generation apparatus according to claim 15, characterised in that:
the armature element has the shape of a cylinder, in which a plurality of windings or conductor sectors are circumferentially arranged on one or more planes perpendicular to the axis of the cylinder, the armature element being coaxial to a hollow cylinder having the function of an inductor which carries circumferentially a plurality of induction elements provided on one or more planes perpendicular to the axis of the cylinder and arranged in such a manner that each of them is located at a respective winding of the armature element; and
said shielding structure supporting a plurality of shielding sectors is represented by a hollow cylinder placed coaxially in the air gap between armature element and inductor element, wherein the shielding structure in operation is in translatory oscillation along the axis of said coaxial cylinders.

27. The electric current generation apparatus according to claim 15, characterised in that:
the armature element has the shape of a hollow solid geometric figure, in which a plurality of windings or conductor sectors are arranged perimetrically on one or more planes perpendicular to the axis of the hollow geometric figure, the armature element being coaxial to a hollow geometric figure with the function of inductor, which has the same geometric shape as the inductor element and which carries perimetrically a plurality of induction elements provided on one or more planes perpendicular to the axis of the solid figure and arranged in such a way that each of them is located at a respective winding of the armature element; and
said shielding structure supporting a plurality of shielding sectors is represented by a hollow geometric figure coaxially arranged in the air gap between armature element and inductor element, wherein the shielding structure in operation is in translatory oscillation along the axis of said coaxial solid figures.

28. The electric current generation apparatus according to claim 27, wherein the geometrical shape of said armature element, inductor element and shielding structure is a hollow parallelepiped.
